(19) United States
(12) Patent Application Publication
(10) Pub. No.: US 2025/0355699 A1
(43) Pub. Date: Nov. 20, 2025

(54) LIVE MIGRATION OF A RUNNING PROCESS

(71) Applicant: International Business Machines Corporation, Armonk, NY (US)

(72) Inventors: Benjamin Isinger, Stuttgart (DE); Jeremias Werner, Spangenberg (DE); Daniel Pittner, Esslingen am Neckar (DE); Michael Haide, Jettingen (DE)

(21) Appl. No.: 18/747,652

(22) Filed: Jun. 19, 2024

(30) Foreign Application Priority Data
May 16, 2024 (GB) 2406933.8

(51) Int. Cl. G06F 9/48

(52) U.S. Cl. CPC G06F 9/4856

(57) ABSTRACT

Disclosed herein is a computer implemented method of operating a computing environment to perform a live migration of a running process from a current computing node to an alternative computing node. The current computing node is configured for executing an application binary using a sandboxed runtime environment that comprises an application binary interface. The alternative computing node is configured for executing the application binary using the sandboxed runtime environment that comprises the application binary interface. The application binary interface has a node hardware independent instruction set. The method comprises: monitoring the running process on the current computing node to see if it meets a predetermined transfer criterion; adding the running process to a workload queue if the predetermined transfer criterion is detected; and migrating the running process from the current computing node to the alternative computing node. The migration of the running process comprises a transfer of stateful network connections.

### BACKGROUND

The present invention relates to the orchestration of workloads in a distributed computing system, and more specifically, to a method for live migration of a running process from a current computing node to an alternative computing node.

In modern orchestration systems like Kubernetes an incoming workload will be assigned to machines by a scheduler. Based on some scheduling policy the scheduler tries to make the best placement decision so that ideally workload will be distributed across the system in the best possible way (e.g. with the focus on cost optimization or with the focus on performance optimization). For that the scheduler mostly collects observability data and characteristics from the system (especially the machines that will run the workload) so that it can properly evaluate which placement would satisfy the scheduling policies the most.

### SUMMARY

In one aspect a computer-implemented method of operating a computing environment to perform a live migration of a running process from a current computing node to an alternative computing node is disclosed. The current computing node is configured for executing an application binary using a sandboxed runtime environment that comprises an application binary interface. The alternative computing node is configured for executing the application binary using the sandboxed runtime environment that comprises the application binary interface. The application binary interface has a node hardware independent instruction set. The method comprises continually monitoring the running process on the current computing node to see if it meets a predetermined transfer criterion. The method further comprises adding the running process to a workload queue if the predetermined transfer criterion is detected. The method further comprises migrating the running process from the current computing node to the alternative computing node. The migration of the running process comprises a transfer of stateful network connections from the current computing node to the alternative computing node.

In another aspect, a computer program product comprising a computer-readable storage medium having computer-readable program code embodied therewith is disclosed. Said computer-readable program code is configured to implement embodiments of the computer-implemented method.

In another aspect a computer system is disclosed. The computer system comprises a processor configured for controlling the computer system. The computer system further comprises a memory storing machine-executable instructions configured to perform a live migration of a running process from a current computing node to an alternative computing node. The current computing node is configured for executing an application binary using a sandboxed runtime environment that comprises an application binary interface. The alternative computing node is configured for executing the application binary using the sandboxed runtime environment that comprises the application binary interface. The application binary interface has a node hardware independent instruction set. The execution of said instructions causes said processor to continually monitor the running process on the current computing node to see if it meets a predetermined transfer criterion. The execution of said instructions further causes said processor to add the running process to a workload queue if the predetermined transfer criterion is detected. The execution of said instructions further causes said processor to migrate the running process from the current computing node to the alternative computing node. The migration of the running process comprises a transfer of stateful network connections from the current computing node to the alternative computing node.

### BRIEF DESCRIPTION OF THE DRAWINGS

In the following embodiments of the invention are explained in greater detail, by way of example only, making reference to the drawings in which:

FIG. 1 illustrates an example of a computing environment.

FIG. 2 depicts a cloud computing environment according to an example of the present invention.

FIG. 3 depicts abstraction model layers according to an example of the present invention.

FIG. 4 shows a further view of the computing environment.

FIG. 5 shows a flow chart which illustrates a method of operating the computing environment.

FIG. 6 illustrates a functional view of a computing environment.

FIG. 7 illustrates the implementation of a computing node using WebAssembly.

FIG. 8 illustrates the transfer of a running process from a current computing node to an alternative computing node.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Examples may provide for a computer-implemented method of operating a computing environment to perform a live migration of a running process from a current computing node to an alternative computing node is provided. A running process, as used herein, may be understood as a process or computing process which is in the active state of being executed on the current computing node. A computing node, as used herein, may be understood as a computing device or appliance which is accessible by a network connection and may for example be configured to perform various processes. The current computing node is configured for executing an application binary using a sandboxed runtime environment that comprises an application binary interface. A sandboxed runtime environment, as used herein, may be understood as a runtime environment which is isolated from the actual or machine level runtime environment. The application binary interface may provide an interface between the runtime at the machine level of the computing node and the sandboxed runtime environment. The alternative computing node is configured for executing the application binary using the sandboxed runtime environment that comprises the application binary interface. In this case both the current computing node and the alternative computing node have the same application binary interface and a compatible sandboxed runtime environment. This may be understood as that the applications can be run transparently on both the current computing node and the alternative computing node. The application binary interface has a node hardware independent instruction set. This may also further enable the transfer of the running process from the current computing node to the alternative computing node.

The method comprises continually monitoring the running process on the current computing node to see if it meets a predetermined transfer criterion. The transfer criterion may include such criterion which would indicate that it is beneficial to move the running process from the current computing node to a different computing node such as the alternative computing node. This may include such criterion as the current computing node being used too much or too little or, in other instances, for security considerations such as the running process having dependencies on libraries or binaries which may have known security risks. The method further comprises adding the running process to a workload queue if the predetermined transfer criterion is detected. The adding of the process to the workload queue may be useful in that it makes it available to be transferred to a different computing node, such as the alternative computing node. It should be noted that when the running process is transferred to the workload queue it is still running on the current computing node.

The method further comprises migrating the running process from the current computing node to the alternative computing node. The migration of the running process comprises a transfer of stateful network connections from the current computing node to the alternative computing node. The various nodes may be part of a distributed computing system. Transferring the stateful network connections effectively transfers the running process from the current computing node to the alternative computing node.

This example may be beneficial because it may provide for a seamless means of transferring the running process from the current computing node to an alternative computing node with a minor interruption in the execution of the running process. This may for example be very beneficial when the current computing node is overloaded by the running process. This may enable the transfer of the running process to the alternative computing node without or with minimal losses in computation that has already been expended.

A problem with existing systems is that distributed system tend to dynamically change their characteristics over time. A workload (running process) might disappear from the system or new workload might come in. The same with the machines that are running the system. While the placement decision might have been ideal at the time of the scheduling it might not be ideal anymore after time has passed. One may end up with a system where one has running workloads that are not distributed ideally across the system anymore. Examples may provide for a means of continually revising and updating the distribution of running processes on available computing nodes. Scheduling policies might be better satisfied when the workload would be completely relocated in a different fashion.

In another example, the sandboxed runtime environment is a WebAssembly runtime. The use of the WebAssembly runtime may have the benefit that it provides an efficient and fast environment for execution of the running process as well as providing for a memory-safe and sandboxed execution. WebAssembly (abbreviated Wasm) is an open source binary instruction format for a stack-based virtual machine. Wasm is designed as a portable compilation target for programming languages, enabling deployment on the web for client and server applications. Typically, when WebAssembly sandboxes are used, they may use a compilation target which varies from computing node to computing node. In this example the application binary interface is standardized between the different computing nodes of a networked computing environment. This may provide for better flexibility in moving running processes around as well as a reduction in the latency and time required to transfer a running process from computing node to computing node.

The nature of WebAssembly runtimes allows for easy and fast live migration of workload. Like modern orchestration systems the proposed method may provide, in some examples, a scheduler that schedules incoming workload across available compute capacity. Similar to the Kubernetes scheduler this scheduler is also customizable with custom schedule policies/plugins so that a system administrator would be still able to influence the placement decision based on their needs (e.g., focus on cost or performance, . . . ). An agent running on individual computational nodes may then responsible to react on the placement decisions.

In another example, the current computing node and the alternative computing node have mutually incompatible instruction set architectures. This example may be beneficial because the use of the sandboxed runtime environment and the same application binary phase on both of the sandboxed runtime environments may enable the running process to be run on both the current computing node and the alternative computing node. Mutually incompatible instruction set architectures may for example be found in computing nodes of different classes. For example, the current computing node could be a small or portable computing node such as a smartphone and the alternative computing node could be an edge computing node which has many more computing resources than the current computing node. Although they have mutually incompatible instruction set architectures, the sandboxed runtime environment and the application binary interface nonetheless may enable the running process to be executed on both.

In another example, the sandboxed runtime environment comprises an application memory that is configured for storing random access memory accessible to the running process and an executable of the running process. The sandboxed runtime environment further comprises a state memory configured for storing a runtime state of the running process. This example may be beneficial because the sandboxed runtime environment not only contains a standardized memory model but also a place to store state variables in the runtime state such that the running process can be seamlessly transferred between the current computing node and the alternative computing node.

In another example, migrating the running process from the current computing node to the alternative computing node comprises copying contents of the application memory of the current computing node to the application memory of the alternative computing node. The migration of the running process from the current computing node to the alternative computing node further comprises suspending the running process on the current computing node. The migration of the running process from the current computing node to the alternative computing node further comprises synchronizing the application memory of the alternative computing node with the application memory of the current computing node. In this example, the copying of the application memory from the current computing node to the application memory of the alternative computing node may take time. As such, the suspension of the process does not happen until this copying is completed.

As the running process may have made alterations in the application memory, the synchronization process may enable the application memory of the alternative computing node to be updated such that it matches the application memory of the current computing node once the running process has been suspended on the current computing node. This step of synchronizing could have the effect of reducing the delay or the amount of time that the running process is suspended. The migration of the running process from the current computing node to the alternative computing node further comprises transferring contents of the state memory of the current computing node to the state memory of the alternative computing node. The state memory includes such things as the contents of various registers and other memory which is directly accessible to the runtime. The migration of the running process from the current computing node to the alternative computing node further comprises resuming the running process on the alternative computing node. This example may be beneficial because it provides for a way of transferring the running application from the current computing node to the alternative computing node with minimizing the amount of time where the running process is suspended or not running on either node.

In another example, resuming the running process on the alternative computing node comprises compiling the running process to a machine instruction set of the alternative computing node before copying contents of the application memory and/or transferring contents of the state memory to the alternative computing node. This example may be beneficial because it may enable resuming the running process with the runtime such as the WebAssembly intermediate runtime to the machine instruction set which is best for execution of the particular running process. This may have the effect of accelerating the execution of the running process on the alternative computing node.

In another example, resuming the running process on the alternative computing node comprises using an IP Anycast implementation to announce running of the running process on the alternative computing node to ensure client connections to the running process on the current computing node are terminated. This may be beneficial because it may help to remove errors in sending data to and from the current computing node after the running process has already been transferred to the alternative computing node.

In another example, the current computing node and the alternative computing node comprise a respective agent configured for cooperatively migrating the running process from the current computing node to the alternative computing node. In this example, there is an agent running on each of the current computing node and the alternative computing node. The agents may be software programs or processes which cooperate with each other for the effective exchange of data during the migration of the running process. This may be beneficial because it may provide for the efficiency and more accurate transfer of the running process.

In another example, the agent of the current computing node is configured to detect the predetermined transfer criterion. The current computing node is configured to add the running process to the workload queue if the predetermined transfer criterion is detected. The agent of the alternative computing node is configured for binding the running process to the alternative computing node by recording the binding data descriptive of the running process in a binding database. In this example, the agent running on the current computing node is able to detect when the running process should be transferred to a different computing node. This may provide for a distributed means of making the computing environment run more efficiently.

In another example, the agent of the current computing node is configured for freezing execution of the running process if a predetermined freeze policy is met. This example may be beneficial because in some instances the running process on the current computing node may become unstable, may have grave security risks or errors, or may grossly exceed the computational capacity of the current computing node. Freezing the execution of the running process may provide for a means of preventing any of these adverse situations and enable the running process to be transferred to the alternative computing node without error.

In another example, the predetermined freeze policy comprises the running process exceeding a chosen processing capacity of the current computing node. In another example, the predetermined freeze policy comprises that the running process exceeds a chosen storage capacity of the application memory. In another example, the predetermined freeze policy comprises one or more software components of the running process meeting a predetermined security profile or rating. In another example, the computing environment further comprises a scheduler configured to assign the running process in the workload queue to the alternative computing node using a scheduling algorithm. The scheduler is further configured to bind the running process to the alternative computing node by recording binding data descriptive of the running process in a binding database. This example may be beneficial because it may provide for a means of optimizing the distribution of processes within the various nodes of the computing environment.

In another example, the computing environment further comprises the binding database. In another example, the computing environment further comprises the workload queue.

In another example, the computing environment further comprises a global optimizer component. The global optimizer component may for example be a program running on a computer monitoring the overall computing environment. The global optimizer component is configured for continually monitoring the running process on the current computing node to see if it meets the predetermined transfer criterion. This may for example be useful to have an additional software component that has an overall view of the computing nodes available and monitors them if there is an issue or problem with a running process.

In another example, the predetermined transfer criterion comprises the running process exceeding a predetermined processing capacity of the current computing node. This may for example be useful because if the running process exceeds the processing capacity of a current computing node it may run incorrectly or slowly.

In another example, the predetermined transfer criterion comprises the running process exceeding a predetermined storage capacity of the application memory. In this example if the storage capacity of the application memory is exceeded, this may for example cause a stack overflow or other problem for the running process and may for example cause the process to fail or to return incorrect results.

In another example, the predetermined transfer criterion comprises the running process on the current node has a latency above a predetermined latency. For example, if the running process is not able to respond below the predetermined latency then this may cause problems with other software components on other systems that are using the running process. Moving the running process to the alternative computing node may for example alleviate this problem.

In another example, the running process has a predetermined code or software library dependency. For example, it may be determined that the running process is using portions of code or a software library which has security risks or known problems with them. The method could then be used to move the process from the current computing node to an alternative computing node where the alternative computing node is more secure or more isolated. This may for example provide for improved security of the computing environment. This may for example provide a way to isolate programs which may be compromised due to problems in core snippets of code or libraries which are used by that running process.

In another example, the current computing node is a handheld telecommunication device. The alternative computing node is a remote host. This for example may be advantageous because it may enable an operator to begin the running process on a local handheld telecommunication device such as a smartphone. When the computing capacity of the current computing node is exceeded, then it may be handed off or transferred to a more powerful computing node.

In another example, the remote host is a cloud-based server or an edge-based computing device. This may for example be advantageous because it may provide for a very cost effective and efficient means of transferring running processes from a handheld telecommunication device on the fly to an on-demand computing service such as a cloud-based serve or an edge-based computing device.

In another example, the running process is a large language model (LLM). The predetermined criterion comprises any one of the following: a received LLM prompt line is exceeded and a KV-cache length is exceeded. The LLM In both of these cases a large language model running on a handheld telecommunication device may suddenly find that it is no longer able to properly execute the large language model. This is a concrete example of where the running process is advantageously moved from the current computing node to an alternative computing node. The LLM prompt line is the text or values input into an LLM. If the prompt is too long, then it may be too difficult for the current computing node to process. The KV-cache refers to the Key and Value cache.

When a prompt is fed into a generative model such as an LLM it is tokenized producing the key (k) and the response is the value (v). The decoder of an LLM is typically arranged such that the attention of a token is dependent upon the previous tokens. By caching the keys and values then the attention of the LLM can be focused on the newly entered token or tokens in stead of the LLM having to process the same tokens multiple times. A lighter weight machine may not have the processing power to store and deal with a large KV-cache. If LLM is used repeatedly during the same session the KV-cache will continue to grow and exceed the resources of the current computing node. In this example, the running process (the LLM) is then seamlessly passed to the alternative computing node.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as machine executable instructions 400 that perform a live migration of a running process from a current computing node to an alternative computing node. In addition to block 400, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

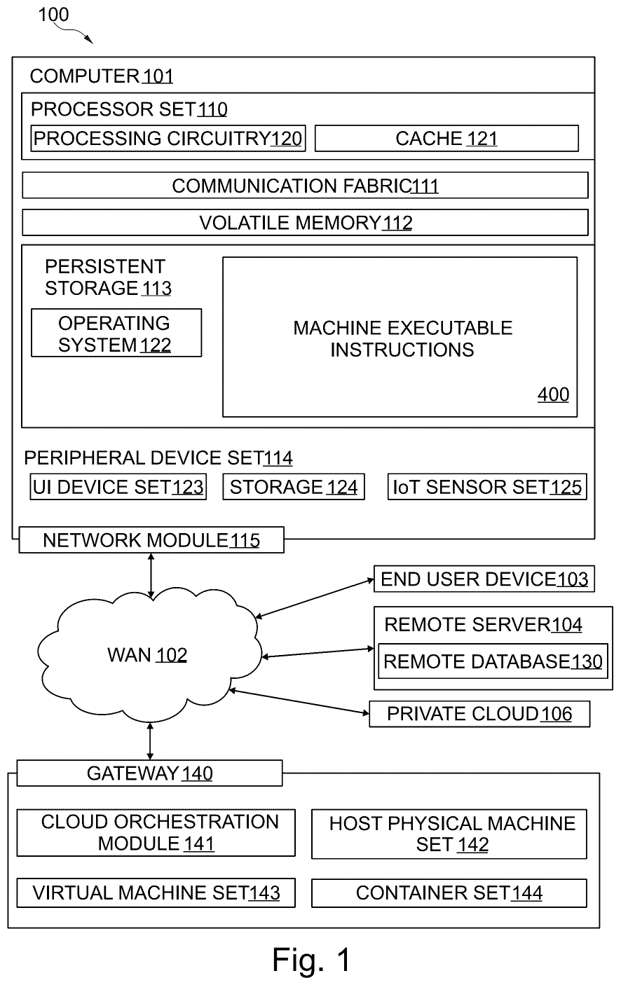

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods.

In computing environment 100, at least some of the instructions for implementing a method of using the machine executable instructions 400 stored in persistent storage 113. For example, the machine executable instructions 400 may be used to control the computing environment to: continually monitoring the running process on the current computing node to see if it meets a predetermined transfer criterion; adding the running process to a workload queue if the predetermined transfer criterion is detected; and migrating the running process from the current computing node to the alternative computing node, wherein the migration of the running process comprises a transfer of stateful network connections from the current computing node to the alternative computing node.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows: On-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service. Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows: Private cloud: the cloud infrastructure is operated solely for an organization. It may be managed by the organization or a third party and may exist on-premises or off-premises. Community cloud: the cloud infrastructure is shared by several organizations and supports a specific community that has shared concerns (e.g., mission, security requirements, policy, and compliance considerations). It may be managed by the organizations or a third party and may exist on-premises or off-premises. Public cloud: the cloud infrastructure is made available to the general public or a large industry group and is owned by an organization selling cloud services. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds). A cloud computing environment is service oriented with a focus on statelessness, low coupling, modularity, and semantic interoperability. At the heart of cloud computing is an infrastructure that includes a network of interconnected nodes.

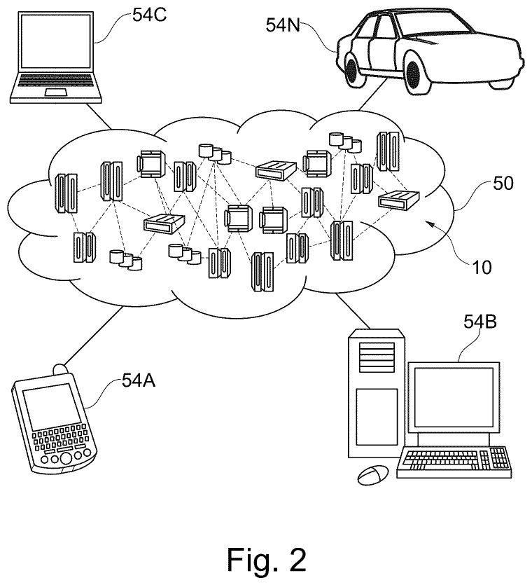

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

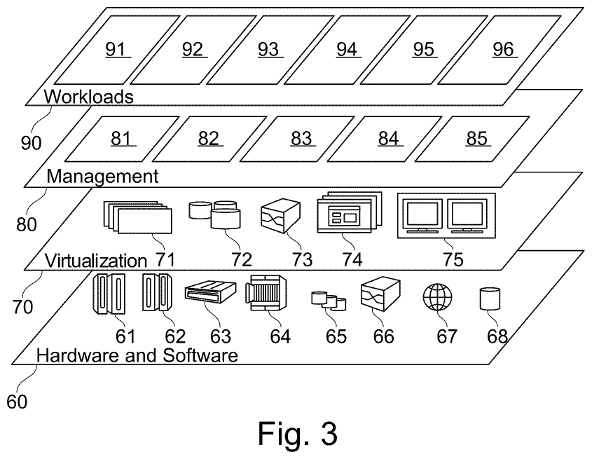

Referring now to FIG. 3, a set of functional abstraction layers provided by cloud computing environment 50 (FIG. 1) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the live migration of a running process from a current computing node to an alternative computing node 96 as was described in the context of FIG. 1 for machine executable instructions 400.

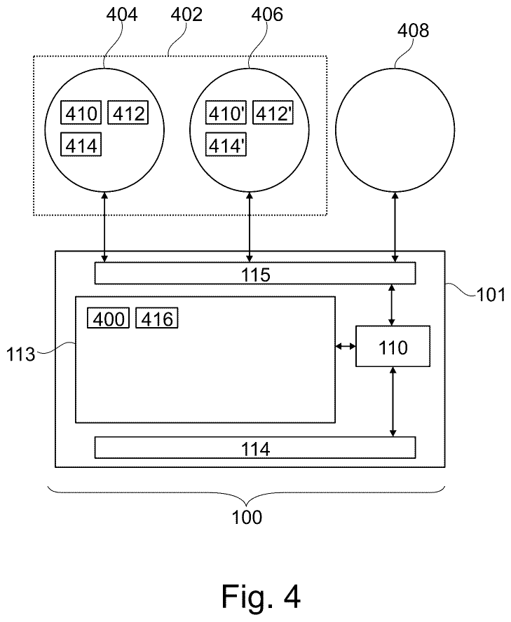

FIG. 4 illustrates a further view of the computing environment 100. Not all details illustrated in FIG. 1 are shown in FIG. 4. A cluster of computing nodes, 404, 406, are shown as being connected to the network module 115 of computer 101. The cluster 402 is shown as comprising a current computing node 404 with the sandbox runtime 410, an application binary interface 412 and the running process 414 before migration. Also within the cluster 402 is the alternative computing node 406, it contains an equivalent sandbox runtime environment 410′, an application binary interface 412′ and the running process 414′ after migration. The computing system 100 is also shown as comprising a workload queue 408, which in this instance is a separate computer or computing node. It may also be implemented by the computer 101.

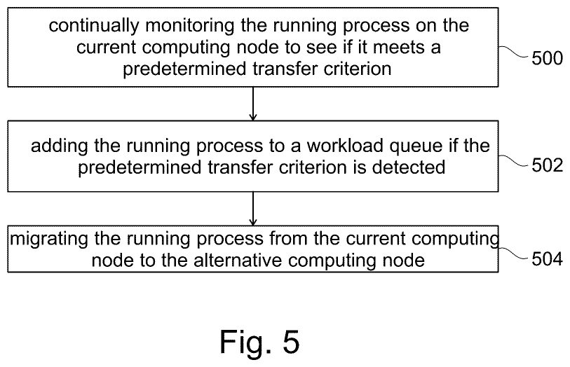

FIG. 5 shows a flowchart which illustrates a method of operating the computer system 100. In step 500, the running process 414 is continually monitored on the current computing node 404 to see if it meets a predetermined transfer criterion 416. When the predetermined transfer criterion 416 is met, step 502 is performed. In step 502 the running process 414 is added to the workload queue 408. Then, in step 504, the running process 414 is migrated from the current computing node 404 to the alternative computing node 406. This migration includes the transfer of stateful network connections 418 from the current computing node 404 to the alternative computing node 406.

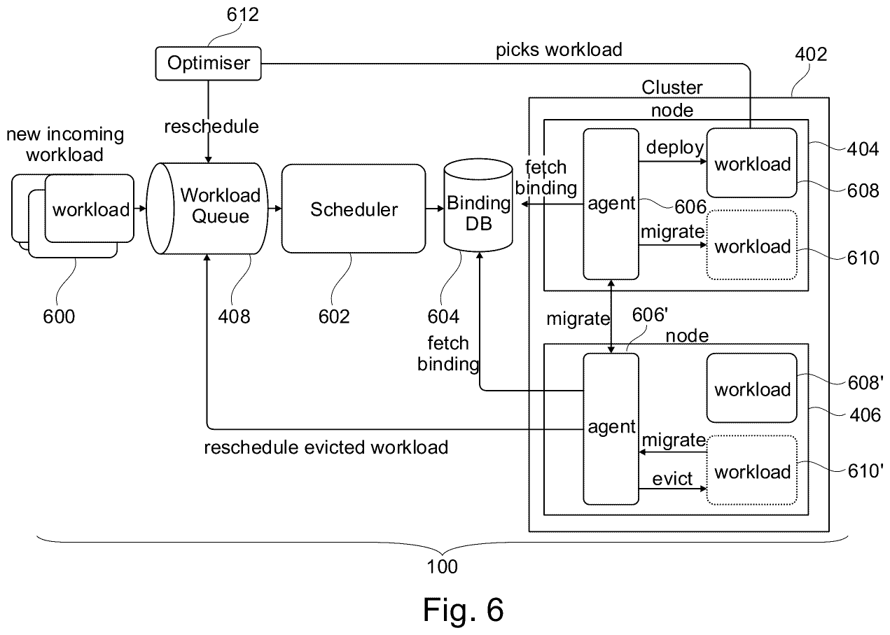

FIG. 6 shows a functional view of the computing system 100. The various software components are illustrated in a functional way and outside of the context of being run on particular processors or computer systems. In this example, a workload queue 406 may receive new or incoming workload 600. The workload queue 406 may hold all workload that needs a (re)binding to a new node. It may also be possible to resort the workload queue 406 using a customized sorting algorithm.

The workload queue 406 uses a scheduler 602 to assign it to various nodes 404, 406 using a scheduler 602. The scheduler 602 may be configured to pick a workload (process to be run) from the workload queue 406 and may (re)bind the workload (process) to a computational node using a scheduling algorithm. To perform this assignment, bindings to the various nodes 404, 406 are recorded in the binding database 604. The binding database contains the (re)binding information for a workload (process running on a computational node).

Each of the nodes 404, 406 has an agent 606, 606′ that may interact with the binding database 604 and fetch bindings which causes a workload (running process) 608, 608′ to be deployed or executed on a particular node 404, 406. In some examples the agents 606, 606′ may monitor the various running processes or workloads, 608, 608′, 610, 610′ and choose to evict them by adding them back to the workload queue 408.

In some examples there may be a global optimizer 612 which monitors the individual running processes 608, 610, 608′, 610′ and may also reschedule them by adding them to the workload queue 408. Agents 606, 606′ may be run on each computational node and may for example fetch bindings and deploy a workload (process) into the sandboxed runtime environment (for example a Wasm runtime). In some examples, the optimizer may constantly observe the computational nodes 414, 416 to optimize the existing workload by “rescheduling” existing workload. To achieve this the global optimizer 612 picks the running process 414 from the current computing node 404 and places it into the workload queue 408.

Examples may continuously schedule new workload into the system but also reschedule existing workload via a live migration to optimize the distribution of the workload within the system. In some examples, there are at least three different scenarios which demonstrate how a workload (process) comes into the workload queue 408 and how they are “processed.”

A first scenario of placing a process into the workload queue 408 may take place when a new workload (process) that needs to be scheduled onto the system. The new workload will be put into the workload queue, the schedule picks up the workload and binds it to a node and stores the information in the binding database 604, an agent 606, 606′ fetches the bound workload from the binding database 604 and deploys into, for example, the Wasm runtime 700 described below.

A second scenario of placing a process or workload into the workload queue 408 may take place when the running process 414 is “evicted” by an agent 606. In this process, the agent 606 decides that it can't or doesn't want to run the workload anymore (based on a customizable eviction policy as was described above), the agent 606 puts the workload into the workload queue 408, the scheduler rebinds workload to a new node and stores the information into the binding database 604, the new agent fetches the rebinding from the binding database 604. It recognizes that it needs to initiate a live migration with the old agent 606, the new agent 606′ communicates with old agent 606 to initiate the live migration, the new agent 606′ prepares runtime accordingly, the old agent 606 transfers all required data and metadata, and the new agents deploys migrated workload into prepared Wasm runtime.

A third scenario of placing the workload into the workload queue 408 may take place in case the workload is “rescheduled” by an optimizer 612. Here, the optimizer 612 picks running workload which should be migrated and puts them into the workload queue 408 and repeats steps described above for the eviction of the process: the scheduler 602 rebinds workload to a new node 606′ and stores the information into the binding database 604, the new agent 606′ fetches the rebinding from the db. It recognizes that it needs to initiate a live migration with the old agent 606, the new agent 606′ communicates with old agent 606 to initiate the live migration, the new agent prepares runtime accordingly, the old agent 606 transfers all required data and metadata, the new agents deploy migrated workload into prepared Wasm runtime.

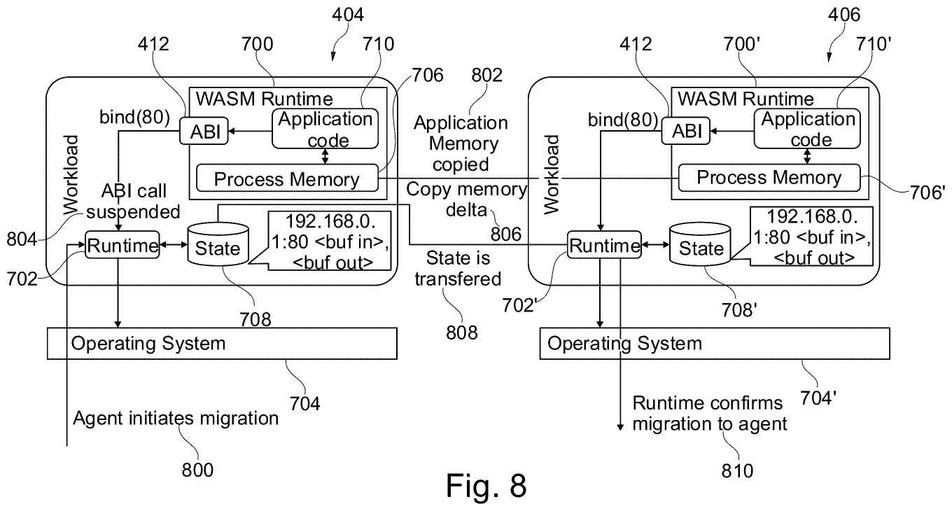

In the case of a rebinding the agent 606, 606′ may interact with a different agent to transfer the running process 414 (see FIG. 8 below). The agent may also evict a workload (process) that the current computational node 404 is unable to run (due to computational limitations) or for which it is no longer desirable to run any more (for example due to security considerations). This eviction may be customized to the particular computational node and may be set using thresholds based on the current performance or computational load of the current computational node 404. During eviction, the running process may be placed into the workload queue 408 but still continues to run on the current computational node 404 until it is migrated to the alternative computational node 406.

Ideally the running process 414 would be rebound to the alternative computational node 406 and migration of the running process is initiated. This may not necessarily happen in a timely fashion. To account for this possibility, some examples may have a freeze policy which allows suspension of the running process. This freeze policy would make the running process hibernate until the running process is rebound to the alternative computing node 406. This process may include freezing the running process and then making a snapshot of the running process. When the running process is bound to the alternative computing node 406 it is then reinitiated.

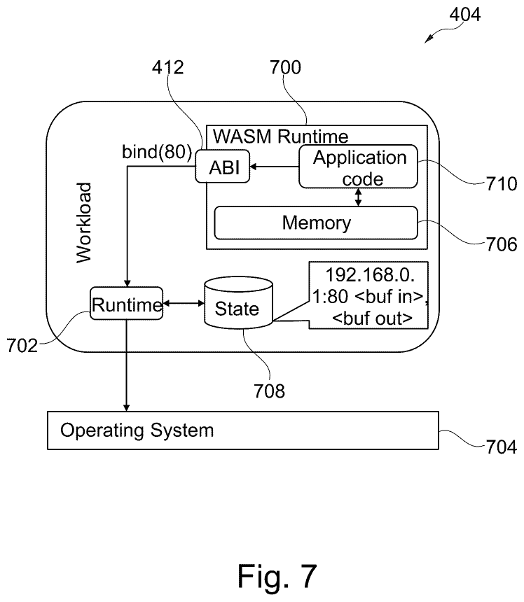

FIG. 7 illustrates an example of a current computing node 404 that is implemented using the WebAssembly runtime 700. The WebAssembly runtime 700 comprises the application binary interface 412 that interfaces with the WebAssembly binary executable 710 for the running process. The binary 710 has access to an application memory 706. The application binary interface 412 provides an interface to a runtime 702 of the machine implementing the current computing node 404. This runtime 702 has access to a state memory 708 which records state variables of the virtual processor implementing the runtime 702. The runtime 702 is shown as interacting with the operating system 704.

FIG. 8 illustrates the transfer or the running process from the current computing node 404 to the alternative computing node 406 using the WebAssembly runtimes 700 illustrated in FIG. 7. The alternative computing node 406 is shown as having its own implementation of the WebAssembly runtime 700′ that comprises the same application binary interface 412 and its own application memory 706. On this node 406 there is also its own machine runtime 702′ and state memory 708′. The runtime 702′ interacts with the local operating system 704′ of the alternative computing node 406. Various arrows are used to illustrate the steps performed in migrating the running process 710 to the alternative computing node 406 as running process 710′. In step 800, the agent 606 initiates the migration. This could also be performed by the global optimizer 612. In step 802, the contents of the application memory 706 of the current computing node 404 is copied to the application memory 706′ of the alternative computing node 406. In step 804, the running process on the current computing node 404 is stopped. In step 806, the application memory 706′ is synchronized with the application memory 706 of the current computing node 404. In step 808, the contents of the state memory 708 of the current computing node 404 is transferred to the state memory 708′ of the alternative computing node 406. In step 810, the transfer is complete, and the running process is resumed on the alternative computing node 406.

Various examples may possibly be described by one or more of the following features in the following numbered clauses:

Clause 1. A computer implemented method of operating a computing environment to perform a live migration of a running process from a current computing node to an alternative computing node, wherein the current computing node is configured for executing an application binary using a sandboxed runtime environment that comprises an application binary interface, wherein the alternative computing node is configured for executing the application binary using the sandboxed runtime environment that comprises the application binary interface, wherein the application binary interface has a node hardware independent instruction set, wherein the method comprises:
continually monitoring the running process on the current computing node to see if it meets a predetermined transfer criterion;
adding the running process to a workload queue if the predetermined transfer criterion is detected; and
migrating the running process from the current computing node to the alternative computing node, wherein the migration of the running process comprises a transfer of stateful network connections from the current computing node to the alternative computing node.

Clause 2. The computer implemented method of clause 1, wherein the sandboxed runtime environment is a WebAssembly runtime.

Clause 3. The method of clause 1 or 2, wherein the current computing node and the alternative computing node have mutually incompatible instruction set architectures.

Clause 4. The computer implemented method of any one of clauses 1 through 3, wherein the sandboxed runtime environment comprises an application memory configured for storing random access memory accessible to the running process and an executable of the running process, and a state memory configured for storing a runtime state of the running process.

Clause 5. The computer implemented method of clause 4, wherein migrating the running process from the current computing node to the alternative computing node comprises:
copying contents of the application memory of the current computing node to the application memory of the alternative computing node;
suspending the running process on the current computing node;
synchronizing the application memory of the alternative computing node with the application memory of the current computing node;
transferring contents of the state memory of the current computing node to the state memory of the alternative computing node; and
resuming the running process on the alternative computing node.

Clause 6. The computer implemented method of clause 5, wherein resuming the running process on the alternative computing node comprises any one of the following:
compiling the running process to a machine instruction set of the alternative computing node before copying contents of the application memory and/or transferring contents of the state memory to the alternative computing node, and
using an IP Anycast implementation to announce running of the running process on the alternative computing node to ensure client connections to the running process on the current computing node are terminated, and combinations thereof.

Clause 7. The computer implemented method of clause 5 or 6, wherein the current computing node and the alternative computing node comprise a respective agent configured for cooperatively migrating the running process from the current computing node to the alternative computing node.

Clause 8. The computer implemented method of clause 7, wherein the agent of the current computing node is configured to detect the predetermined transfer criterion, wherein the current computing node is configured to add the running process to the workload queue if the predetermined transfer criterion is detected, wherein the agent of the alternative computing node is configured for binding the running process to the alternative computing node by recording binding data descriptive of the running process in a binding database.

Clause 9. The computer implemented of clause 7 or 8, wherein the agent of the current computing node is configured for freezing execution of the running process if a predetermined freeze policy is met.

Clause 10. The computer implemented method of clause 9, wherein the predetermined freeze policy comprises any one of the following: the running process exceeds a chosen processing capacity of the current computing node and the running process exceeds a chosen storage capacity of the application memory.

Clause 11. The computer implemented method of any one of the preceding clauses, wherein the computing environment further comprises a scheduler configured to assign the running process in the workload queue to the alternative computing node using a scheduling algorithm, wherein the scheduler is further configured to bind the running process to the alternative computing node by recording binding data descriptive of the running process in a binding database.

Clause 12. The computer implemented method of any one of clauses 8 to 11, wherein the computing environment further comprises the binding database.

Clause 13. The computer implemented method of any one of the preceding clauses, wherein the computing environment further comprises the workload queue.

Clause 14. The computer implemented method of any one of the preceding clauses wherein the computing environment further comprises a global optimizer component, wherein the global optimizer component is further configured for continually monitoring the running process on the current computing node to see if it meets the predetermined transfer criterion.

Clause 15. The computer implemented invention of clause 14, wherein the predetermined transfer criterion comprises any one of the following:
the running process exceeds a predetermined processing capacity of the current computing node,
the running process exceeds a predetermined storage capacity of the application memory,
the running process on the current computing node has a latency above a predetermined latency,
the running process has a predetermined code or software library dependency, and combinations thereof.

Clause 16. The computer implemented method of any one of the preceding clauses, wherein the current computing node is a handheld telecommunications device, and wherein the alternative computing node is a remote host.

Clause 17. The computer implemented method of clause 16, wherein the remote host is any one of the following: a cloud-based server and an edge-based computing device.

Clause 18. The computer implemented method of any one of the preceding clauses, wherein the running process is a large language model, wherein the predetermined criterion comprises anyone of the following: a received LLM prompt length is exceeded, a KV-cache length is exceeded, and combinations thereof.

Clause 19. A computer program product comprising a computer-readable storage medium having computer-readable program code embodied therewith, said computer-readable program code configured to implement the method of any one of clauses 1 through 18.

Clause 20. A computer system comprising:
a processor configured for controlling said computer system; and
a memory storing machine executable instructions configured to perform a live migration of a running process from a current computing node to an alternative computing node, wherein the current computing node is configured for executing an application binary using a sandboxed runtime environment that comprises an application binary interface, wherein the alternative computing node is configured for executing the application binary using the sandboxed runtime environment that comprises the application binary interface, wherein the application binary interface has a node hardware independent instruction set, wherein execution of said instructions causes said processor to:
continually monitor the running process on the current computing node to see if it meets a predetermined transfer criterion;
add the running process to a workload queue if the predetermined transfer criterion is detected; and
migrate the running process from the current computing node to the alternative computing node,
   wherein the migration of the running process comprises a transfer of stateful network connections from the current computing node to the alternative computing node.

What is claimed is:

1. A computer implemented method of operating a computing environment to perform a live migration of a running process from a current computing node to an alternative computing node, wherein the current computing node is configured for executing an application binary using a sandboxed runtime environment that comprises an application binary interface, wherein the alternative computing node is configured for executing the application binary using the sandboxed runtime environment that comprises the application binary interface, wherein the application binary interface has a node hardware independent instruction set, wherein the method comprises:
continually monitoring the running process on the current computing node to see if it meets a predetermined transfer criterion;
adding the running process to a workload queue if the predetermined transfer criterion is detected; and
migrating the running process from the current computing node to the alternative computing node, wherein the migration of the running process comprises a transfer of stateful network connections from the current computing node to the alternative computing node.

2. The computer implemented method of claim 1, wherein the sandboxed runtime environment is a WebAssembly runtime.

3. The computer implemented method of claim 1, wherein the current computing node and the alternative computing node have mutually incompatible instruction set architectures.

4. The computer implemented method of claim 1, wherein the sandboxed runtime environment comprises an application memory configured for storing random access memory accessible to the running process and an executable of the running process, and a state memory configured for storing a runtime state of the running process.

5. The computer implemented method of claim 4, wherein migrating the running process from the current computing node to the alternative computing node comprises:
copying contents of the application memory of the current computing node to the application memory of the alternative computing node;
suspending the running process on the current computing node;
synchronizing the application memory of the alternative computing node with the application memory of the current computing node;
transferring contents of the state memory of the current computing node to the state memory of the alternative computing node; and
resuming the running process on the alternative computing node.

6. The computer implemented method of claim 5, wherein resuming the running process on the alternative computing node comprises any one of the following:
compiling the running process to a machine instruction set of the alternative computing node before copying contents of the application memory and/or transferring contents of the state memory to the alternative computing node, and
using an IP Anycast implementation to announce running of the running process on the alternative computing node to ensure client connections to the running process on the current computing node are terminated, and
combinations thereof.

7. The computer implemented method of claim 5, wherein the current computing node and the alternative computing node comprise a respective agent configured for cooperatively migrating the running process from the current computing node to the alternative computing node.

8. The computer implemented method of claim 7, wherein the agent of the current computing node is configured to detect the predetermined transfer criterion, wherein the current computing node is configured to add the running process to the workload queue if the predetermined transfer criterion is detected, wherein the agent of the alternative computing node is configured for binding the running process to the alternative computing node by recording binding data descriptive of the running process in a binding database.

9. The computer implemented method of claim 7, wherein the agent of the current computing node is configured for freezing execution of the running process if a predetermined freeze policy is met.

10. The computer implemented method of claim 9, wherein the predetermined freeze policy comprises any one of the following: the running process exceeds a chosen processing capacity of the current computing node, the running process exceeds a chosen storage capacity of the application memory, and as the running process has dependencies on libraries or binaries which may have known security risks.

11. The computer implemented method of claim 1, wherein the computing environment further comprises a scheduler configured to assign the running process in the workload queue to the alternative computing node using a scheduling algorithm, wherein the scheduler is further configured to bind the running process to the alternative computing node by recording binding data descriptive of the running process in a binding database.

12. The computer implemented method of claim 8, wherein the computing environment further comprises the binding database.

13. The computer implemented method of claim 1, wherein the computing environment further comprises the workload queue.

14. The computer implemented method of claim 1, wherein the computing environment further comprises a global optimizer component, wherein the global optimizer component is further configured for continually monitoring the running process on the current computing node to see if it meets the predetermined transfer criterion.

15. The computer implemented method of claim 14, wherein the predetermined transfer criterion comprises any one of the following:
the running process exceeds a predetermined processing capacity of the current computing node,
the running process exceeds a predetermined storage capacity of the application memory,
the running process on the current computing node has a latency above a predetermined latency,
the running process has a predetermined code or software library dependency, and
combinations thereof.

16. The computer implemented method of claim 1, wherein the current computing node is a handheld telecommunications device, and wherein the alternative computing node is a remote host.

17. The computer implemented method of claim 16, wherein the remote host is any one of the following: a cloud-based server and an edge-based computing device.

18. The computer implemented method of claim 1, wherein the running process is a large language model, wherein the predetermined criterion comprises anyone of the following: a received LLM prompt length is exceeded, a KV-cache length is exceeded, and combinations thereof.

19. A computer program product comprising a computer-readable storage medium having computer-readable program code embodied therewith, said computer-readable program code configured to implement a method of operating a computing environment to perform a live migration of a running process from a current computing node to an alternative computing node, wherein the current computing node is configured for executing an application binary using a sandboxed runtime environment that comprises an application binary interface, wherein the alternative computing node is configured for executing the application binary using the sandboxed runtime environment that comprises the application binary interface, wherein the application binary interface has a node hardware independent instruction set, wherein the method comprises:
continually monitoring the running process on the current computing node to see if it meets a predetermined transfer criterion;
adding the running process to a workload queue if the predetermined transfer criterion is detected; and
migrating the running process from the current computing node to the alternative computing node, wherein the migration of the running process comprises a transfer of stateful network connections from the current computing node to the alternative computing node.

20. A computer system comprising:
a processor configured for controlling said computer system; and
a memory storing machine executable instructions configured to perform a live migration of a running process from a current computing node to an alternative computing node, wherein the current computing node is configured for executing an application binary using a sandboxed runtime environment that comprises an application binary interface, wherein the alternative computing node is configured for executing the application binary using the sandboxed runtime environment that comprises the application binary interface, wherein the application binary interface has a node hardware independent instruction set, wherein execution of said instructions causes said processor to:
continually monitor the running process on the current computing node to see if it meets a predetermined transfer criterion;
add the running process to a workload queue if the predetermined transfer criterion is detected; and
migrate the running process from the current computing node to the alternative computing node, wherein the migration of the running process comprises a transfer of stateful network connections from the current computing node to the alternative computing node.
